(19) United States
(12) Patent Application Publication
(10) Pub. No.: US 2013/0268156 A1
(43) Pub. Date: Oct. 10, 2013

(54) Data Privacy Mechanism

(71) Applicants: Robert Wilhelm Schumann, Oakton, VA (US); David G. Grossman, Vienna, VA (US)

(72) Inventors: Robert Wilhelm Schumann, Oakton, VA (US); David G. Grossman, Vienna, VA (US)

(21) Appl. No.: 13/441,844

(22) Filed: Apr. 7, 2012

(51) Int. Cl. G06F 7/00

(52) U.S. Cl. 701/31.4

(57) ABSTRACT

A vehicle data privacy mechanism comprising a first port, a second port and a processor. The first port configured to connect to an on-board diagnostic system. The second port configured to connect to a monitor, the monitor originally configured to connect to the on-board diagnostic port. The processor configured to: generate managed data configured to appear as if it originates from the on-board diagnostic system; and send the managed data to the second port.

### BRIEF DESCRIPTION OF THE SEVERAL VIEWS OF THE DRAWINGS

FIG. 1A is a physical diagram of an example diagram of a Data Link Connector (DLC).

FIG. 1B illustrates signal definitions for the example connector of FIG. 1A.

FIG. 2 is a block diagram of a data privacy device as per an aspect of an embodiment of the present invention.

FIG. 3A and FIG. 3B is a diagram showing how an example of how a data privacy device may connect with an on-board diagnostic system and a monitor as per an aspect of an embodiment of the present invention.

FIG. 4 is a block diagram of a data privacy device as per an aspect of an embodiment of the present invention.

FIG. 5 is an example circuit diagram of a CAN/processor interface as per an aspect of an embodiment of the present invention.

FIG. 6 is an example flow diagram of an aspect of an embodiment of the present invention running in a real-time vehicle/monitor mode.

FIG. 7 is an example flow diagram of an aspect of an embodiment of the present invention running in a simulation mode.

FIG. 8 is an example diagram of a data privacy monitor case configured to operate in conjunction with a data privacy device as per an aspect of an embodiment of the present invention.

FIG. 9 is an example plot of raw and smoothed speed data as per an aspect of an embodiment of the present invention.

FIG. 10A, FIG. 10B, FIG. 10C and FIG. 10D show example illustrations addition embodiments that may include the addition of a second data privacy device as per aspect(s) of embodiment(s) of the present invention.

### DETAILED DESCRIPTION OF EMBODIMENTS

Embodiments of the present invention protect and obscure personal data potentially obtained from an On Board Diagnostic (OBD) system.

On-Board Diagnostic systems refer to a self-diagnostic and reporting capability for other larger systems. OBD's are often used in vehicles. In the case of vehicles, OBD systems may provide a vehicle owner or a repair technician access to operational or state of health information for various vehicle sub-systems. The amount of diagnostic information available via OBD has continuously increased since the introduction in the early 1980s of on-board vehicle computers, which made OBD possible. Early instances of OBD would simply illuminate a malfunction indicator light if a problem was detected, but would not provide any information as to the nature of the problem. Some modern OBD implementations use a digital communications port to provide real-time data in addition to a series of diagnostic trouble codes, or DTCs, which may allow the rapid identification and remedy of malfunctions within a vehicle.

Vehicles manufactured after 1996 contain an OBD port that provides access to real-time and historical information about how the vehicle is running. OBD II is a second version of a standard for communicating this information. At least some of the data available through the OBD II system monitors engine emissions and may be used to track down problems that cause cars to pollute more than normal. Some manufacturers have extended the standard to contain data about other subsystems and their problems and performance. Some of the extended codes may include proprietary codes that help pinpoint malfunctions on a specific vehicle.

OBD II generally reflects the cause of a vehicle's “check engine” light when there is a problem, and may be a mechanic's tool of first recourse when vehicle symptoms have no obvious cause.

Since the data's transmission format and content is often standardized, a number of third parties have developed hardware to detect and display these codes. Some of these outboard devices may further hook up to, or include memory devices, laptops or other computing devices to capture this data not just for immediate display but also for later aggregation and analysis. Some of these devices may log data autonomously.

The OBD II port may allow a vehicle to report different kinds of information such as, but not limited to: Diagnostic Trouble Codes (DTCs), real-time data, historical data, and freeze frame data. DTCs may include error codes that may be looked up to determine what problem a vehicle is experiencing. For example, the DTC code P0302 means “cylinder 2 misfire detected”. If the condition that caused the DTC persists, the car's computer may turn on a “check engine” light. Real-time data may include raw sensor data reported to the OBD computer. This data may be helpful for troubleshooting problems and monitoring engine performance. Freeze frame data may include a snapshot of the real-time sensor feeds at the time of a DTC condition. An auto mechanic may use this data to figure out what was going on at the time a vehicle's “check engine” light went on.

The OBD II port may also be used by connected tools to control and update the vehicles on-board systems. This includes, for example, clearing the Change Oil light as well as other diagnostic trouble codes that might cause the check engine light to go on.

Within the OBD II standard, there are several protocols for transferring data from the car to a diagnostic device. These protocols may help various computer systems within a vehicle to communicate. For example, the CAN protocol(s) may enable a GPS system to talk to the OBD system or a DVD player. It is envisioned that some embodiments of the present invention may employ alternative protocols to enable communication of information throughout a vehicle.

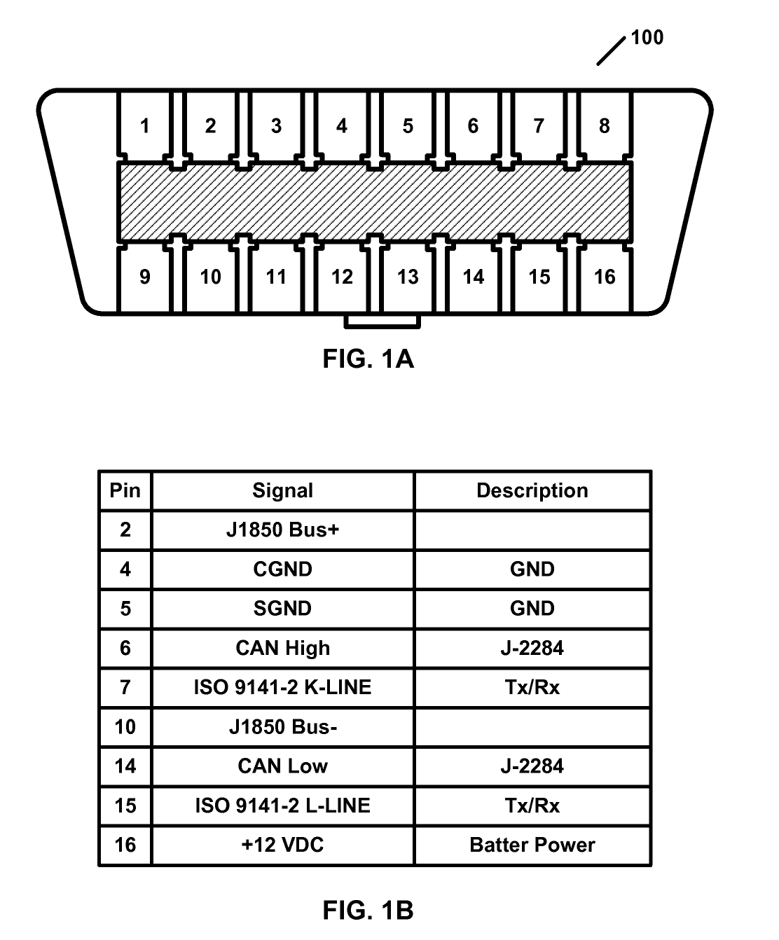

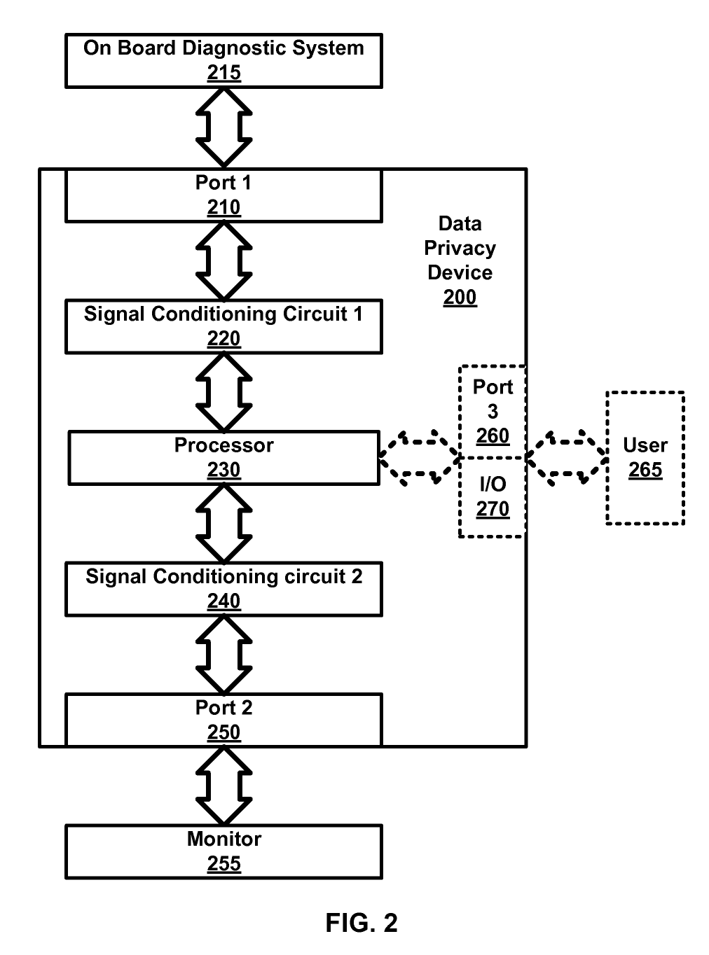

FIG. 1A is a physical diagram of an example Data Link Connector (DLC). Some embodiments of the present invention may be configured to connect to this example connector, which happens to be an OBD II port connector. This example DLC is a 16-pin female connector that's usually located within three feet of the driver under the dashboard. This example connector is a standard connector defined by the SAE J1962 (ISO 15031-3) standard. FIG. 1B illustrates signal definitions for this example connector. One of the pins on the OBD II connector is power from the vehicle's battery, which means that OBD II connected devices may not need batteries or an external power source. It is envisioned that some vehicles may use other types of connectors.

Real-time data available through a port, such as an OBD port, may include vehicle speed, engine RPMs, air temperature, individual wheel speeds, braking performance, and the readings of various sensors (typically oxygen sensors and knock-detectors). Not every vehicle passes the same information over the interface, so data streams may vary.

The standardized OBD digital communications port may be accessible in the compartment of a driving vehicle. There are many types of devices that use this port including hand held scan tools, PC-based scan tools and analysis platforms, data loggers, emission testing equipment and driver's supplementary vehicle instrumentation.

There are a number of tools available that interface through the OBD bus. Examples include a BR-3 scan tool by OBD Diagnostics of Pulaski, Tenn.; and a dashboard scan tool and data logging computer by Autoterra of Fallbrook, Calif. Examples of consumer devices that use OBD data to provide useful data to drivers include ScanGauge by Linear Logic of Mesa, Ariz. which reads and clears DTCs, provides a digital dashboard, and has a trip computer; and CarChip by Davis Instruments of Hayward, Calif. which logs data. These types of tools may be used to capture vehicle data both while the vehicle is static and while the vehicle is in operation for analysis. For example, engine and vehicle monitoring under normal operation may be logged for the purpose of diagnosis or tuning a vehicle.

There is a possibility that the OBD digital communications port may be used by a data logger to record, among other things, personal information, such as a drivers driving performance, derived from the use of a vehicle. Some automobile insurance companies offer reduced premiums if installed OBD vehicle data loggers indicate that a driver's behavior meets satisfactory requirements. This is a form of auto insurance risk selection. Some companies, such as fleet vehicle operators, may use OBD digital communications port monitoring of driver performance. Analysis of historical vehicle performance data (often referred to as “black box” data) may be performed on a periodic basis, automatically transmitted wirelessly to a third party or retrieved for forensic analysis after an event such as an accident, traffic infringement or mechanical fault. However, in some cases, an OBD digital communications port may be used without a person's permission to track their vehicular behavior.

Some embodiments may just log all of the interactions between the monitor and the OBD port. The logged data may be used later to determine what information the logger requested and collected.

The CAN standard defines example OBD II codes. The first character of the OBD II code may identify a system such as “P” for powertrain, “B” for body, “C” for chassis, and “U” for undefined. The second character of the OBD II may identify whether the code is a generic code (same on all OBD-II equipped vehicles), or an enhanced manufacturer specific code. The third character of the OBD II code may denote the type of sub-system that pertains to the code such as: “1” for Emission Management (Fuel or Air); “2” for Injector Circuit (Fuel or Air); “3” for Ignition or Misfire; “4” for Emission Control; “5” for Vehicle Speed & Idle Control; “6” for Computer & Output Circuit; “7” for Transmission; and “8” for Transmission. The fourth and fifth characters of the OBD II code, along with the others, may be variable and relate to particular problems. Typically, these codes may be looked up in OBD II trouble code tables.

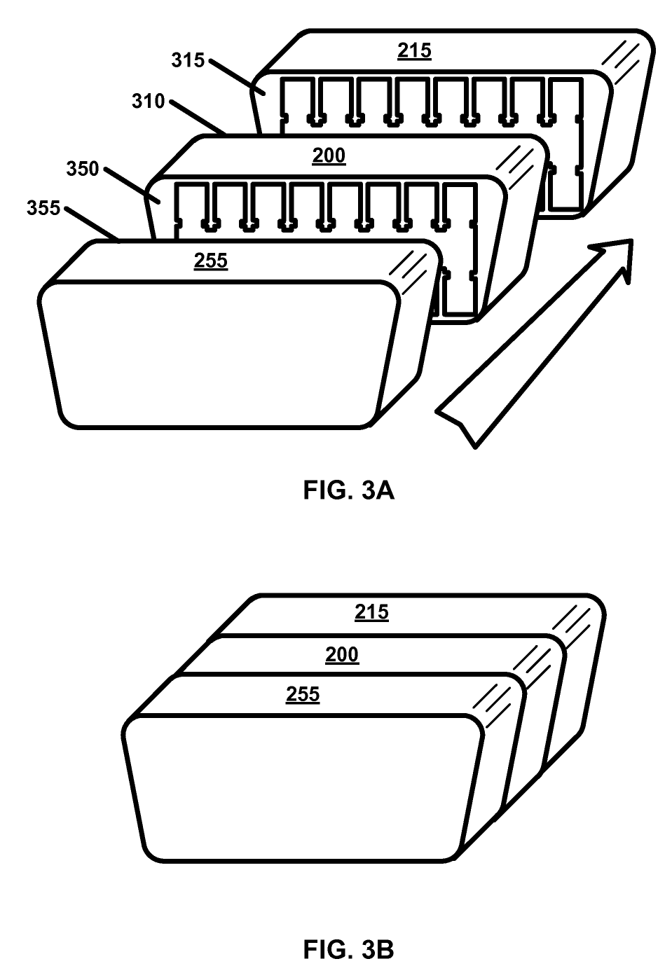

FIG. 2 is a block diagram of a data privacy device 200 as per an aspect of an embodiment of the present invention. As illustrated, the data privacy device 200 includes a first port 210, a second port 250 and a processor 230.

According to some embodiments, the first port 210 may be configured to communicatively connect to an on-board diagnostic system 215. The first port 210 may be configured to receive OBD data. The on-board diagnostic system 215 may be a vehicle on-board diagnostic system. Some on-board diagnostic systems are implemented via a single electronic control unit (ECU) that may collect and store information and communicate with a monitor attached to the OBD port. Other on-board diagnostic systems may be implemented as a collection of ECU's which connect on the CAN bus and each of which provides the historical and real-time data for their specific subsystem.

According to some embodiments, the second port 250 may be configured to communicatively connect to a monitor 255 that may be configured to communicatively connect to the on-board diagnostic system 215. The monitor 255 may be a vehicle monitor.

According to some embodiments, the processor 230 may be configured to send managed data to the second port 250, the managed data may be configured to appear as if it originates from the on-board diagnostic system 215. Processor 230 may include any number of devices that have a capability to perform at least some of the functions described in this disclosure. Examples of such devices include dedicated microcontroller(s), microprocessor(s), programmable hardware, computers, laptops or the like.

The managed data may be many types of data depending on the source of the data. In some embodiments, the managed data may be managed vehicle data. At least some of the managed data may have been received at the first port 210. The processor 230 may be further configured to generate at least some of the managed data by modifying selected data received at the first port 210.

According to some embodiments, at least some of the managed data may be simulated. Simulated managed data may be generated by the processor, or in some embodiments, be provided by another source such as an external computing machine, a memory device or the like, or may be generated based on information provided by another source. At least some of the simulated data may employ information determined through prior communication(s) through the first port 210 to a device such as on-board diagnostic system 215. At least some of the simulated data may represent driving characteristic data. Driving characteristic data may include data that represents the operation or behavior of the vehicle. Examples of driving characteristic data may include, but is not limited to, acceleration data characteristics, braking data characteristics, rpm data characteristics, speed data characteristics, g-force data characteristics or the like.

At least some of the managed data may be modified speed data. Similarly, the managed data may be configured to make a vehicle employing an on-board diagnostic system 215 to appear to be at least one of the following: turned off; driving slowly; accelerating slowly; decelerating slowly; a combination thereof or the like. The managed data may also be configured to generally track the “real” operation of the vehicle, but smooth out excessive acceleration, deceleration and other characteristics of vehicle operations.

Communications between the on-board diagnostic system 215 and port 1 210 may employ many different types of communication interfaces. Similarly, communications between the monitor and port 2 250 may employ different types of communication interfaces. Examples of various types of communication interfaces that may be employed include, but are not limited to: OBD port(s); OBD II port(s); RS-232 port(s); USB port(s); RS-422 port(s); digital port(s); Ethernet port(s); Bluetooth port(s); wireless ports; LIN-Bus or a combination of the above or the like.

Some embodiments may further include a signal conditioning circuit 220 between the first port 210 and the processor 230. Similarly, some embodiments may further include a signal conditioning circuit 240 between the second port 250 and the processor 230. The conditioning circuits 220 and 240 may adapt communication signals and/or protocols between differing standards. For example, processor 230 may wish to communicate using a parallel digital signal while a port may be configured to communicate with a device that is configured to communicate using a serial communications signal. In this example, the conditioning circuit (220 and/or 250) may convert the signals between the parallel and serial configurations. In another example, the processor 230 and device may both communicate using a serial protocol, but at different electrical levels. In this case the signal conditioning circuit (220 and/or 250) may convert those levels. In yet another example, the processor 230 and device may both communicate using a serial protocol, but at different baud rates. In this case the signal conditioning circuit (220 and/or 250) may convert the baud rate, provide synchronization signals, reframe data, or the like.

Additionally, signal conditioning circuit(s) (220 and/or 250) may be configured to selectively emulate a vehicle in an off state, and for example, including under control of processor 230. In these cases, the signal conditioning circuit (220 and/or 250) may adjust voltage pins, or the like to simulate the hardware behavior of a vehicle OBD port 215. Additionally, signal conditioning circuit(s) (220 and/or 250) may be configured to reconfigure pin behavior at port 1 210 and/or port 2 depending upon the hardware connector and/or protocol employed by the vehicle OBD port.

Some embodiments of the present invention may be configured with a third port 260 that is configured to communicate with another device 265 such as a terminal, a processor, configuration device, a user, a combination thereof or the like. Device 265 may enable a user to configure and/or pass data to privacy device 200.

Some embodiments of the present invention may be configured such that port1—230 or Port 2—250 is further configured to communicate with another device 265 such as a terminal, a processor, configuration device, a user, a combination thereof or the like. Device 265 may enable a user to configure and/or pass data to privacy device 200.

Some embodiments may further include an input output interface 270 configured to switch the apparatus between different modes. Examples of input/output interfaces include, but are not limited to switches, buttons, voice command circuitry, wireless interfaces to smart mobile device(s), touchscreen(s), or the like. In one example, the input output interface 270 may include a switch that is configured to provide a logic level to processor 230. The modes may include, but are not limited to: an off mode; a good driver mode; a normal mode; a pass through mode; a simulation mode; a driver training mode, a combination thereof or the like. The input/output interface could employ software/firmware. In the case of when software/firmware is employed, command(s), parameter(s), data or the like may be presented to processor 230 through one of the ports 210, 250 or 260 as well as input output interface 270.

According to some embodiments, a pass-through mode may pass all data back and forth between OBD system 215 and monitor 255 with minimal, or no modification. According to some embodiments, an off mode, may simulate a vehicle in an off state. According to some embodiments, a good driver mode, may manage data from OBD 215 to monitor 255 so that the vehicle appears to be driven by a good driver. This mode may include maintaining limits upon select parameters such as, but not limited to: speed, acceleration, RPM, or the like.

According to some embodiments, a driver training mode may help the driver of a vehicle become more aware of their driving habits and thus able to correct undesired habits. For example, in a training mode, device 200 may use one of the interfaces 210, 250, 260 or 270 to communicate when the vehicle is exceeding some limits such as, but not limited to: an acceleration limit, a deceleration limit, a speed limit, a braking limit, an RPM limit, a combination of the above, or the like. In another embodiment device 200 may signal the operator via visual or audible signals directly when the limits are exceeded. These visual or audible signals may further be differentiated by the type of limit being exceeded. For example the device may beep once when a speed limit is exceeded, while beeping twice in rapid succession when a braking limit is exceeded. The training mode may be used in combination with other modes. For example, in some embodiments, the training mode may be combined with a good driver mode, a normal mode, a pass-through mode, a simulation mode, or the like. In some embodiments, the driver training mode may be run in parallel with other modes. Further the device may allow upload of the captured data which may then be used to review performance showing where the limits were exceeded.

To further the goal of training. Recorded data could be played back through a tool may allow a simulation of the driving experience. This simulation may work in conjunction with a mapping and/or street view tool such as Google maps. In this way, one could after the fact, use the simulation to understand the conditions that caused undesirable behavior such as excessive braking, accelerations, hard cornering or the like.

Some embodiments of the present invention may be implemented as a method. For example, such a method may include one or more processes. One example process may include receiving data from an on-board diagnostic system. Another example process may include employing at least one processor to generate managed data configured to appear as if it originates from the on-board diagnostic system. Yet another example process may include sending the managed vehicle data to a monitor that is configured to connect to the on-board diagnostic system. These processes are only examples. It is envisioned that processes may be implemented to perform any or all of the techniques describer in this disclosure. Some embodiments of the present invention may be implemented as a non-transient computer readable media containing instructions configured to one or more processors to perform methods and/or processes such as those just described.

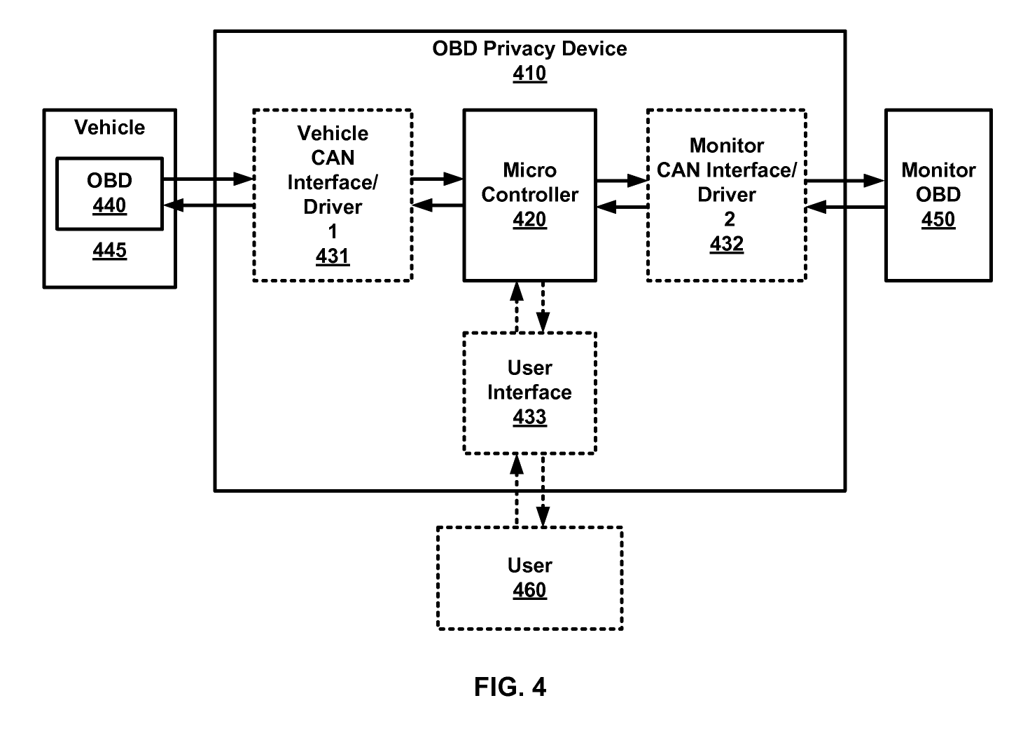

FIG. 3A and FIG. 3B illustrate how a data privacy device 200 may connect between a vehicle OBD 215 and a monitor 255. Monitor 255 may be communicatively connect to privacy device 200 by mating a monitor connector 355 (not shown) and a port 2 connector 350. According to some embodiments, connector 350 may be a female OBD connector and connector 355 may be a male OBD connector. Similarly, vehicle OBD unit 215 may be communicatively connect to privacy device 200 by mating a vehicle OBD connector 315 and a port1 connector 1022 (not shown). According to some embodiments, connector 315 may be a female OBD connector and connector 1022 may be a male OBD connector.

FIG. 3A shows the devices unconnected and FIG. 3B shows the devices connected. These diagrams are not intended to show these elements to scale, but merely to show how they are connected. For example, vehicle OBD 215 may be physically separate from the vehicle OBD connector 315. One or more of the devices and connectors may be connected through cables.

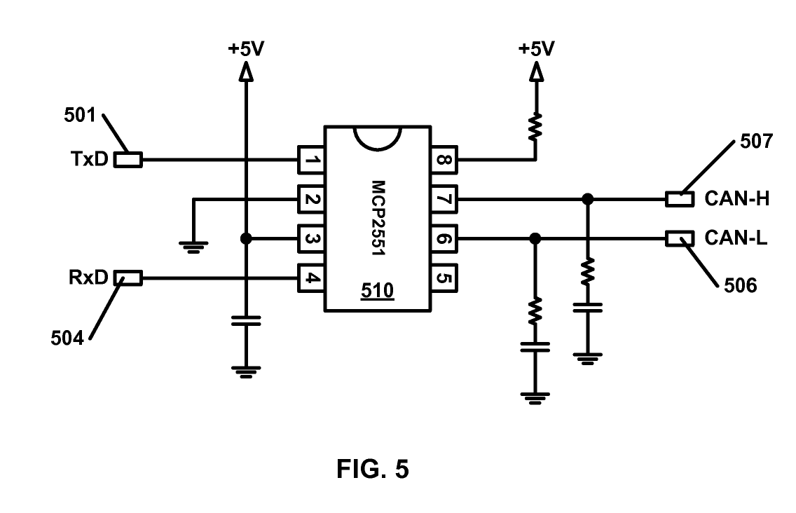

FIG. 4 is a block diagram of a data privacy device as per an aspect of an embodiment of the present invention using a Controller-area network (CAN or CAN-bus) interface. CAN is a vehicle bus standard designed to allow microcontrollers and devices to communicate with each other within a vehicle without a host computer. CAN is a message-based protocol, originally designed specifically for automotive applications but may be used in other fields such as industrial automation and medical equipment. The CAN protocol was officially released in 1986 at the Society of Automotive Engineers (SAE). The Robert Bosch Company of Stuttgart, Germany published the CAN 2.0 specification in 1991. CAN is one of five protocols used in the OBD-II vehicle diagnostics standard.

Embodiments of the CAN II bus employ a pair of wires, often twisted around each other, running around a vehicle and terminated at either end of the two-wire network, often with resistors of about 120 Ohms. The Can bus may be configured to be connected to electronic control units (nodes). Other components, such as sensors, motors, light bulbs, switches, etc. may be wired to the electronic control units. Some vehicles may have a CAN bus system along side other system(s) including communication system(s). A vehicle which uses a CAN bus for on-board diagnostics may respond to an OBD-II request from a tester which uses a CAN bus. From model year 2008 vehicle manufacturers may use the OBD protocol specified in ISO 15765, also known as Diagnostics On CAN.

Two wires of the CAN bus, CAN-H and CAN-L, may have the same voltage when idle (about 2.5V), or a voltage difference of 2V when a signal is placed on the CAN bus. When a signal is placed on the CAN bus the CAN-H line may be at a higher voltage than the CAN-L line. Each electronic control unit may have its own CAN identity code, like an address (may respond to several CAN ID codes). If an electronic control unit is to communicate to another, it may need to know the CAN identity code of the recipient.

A simple check to see if the CAN bus is in use in a vehicle, and accessible via the OBD socket, is to connect a resistance meter across pin 6 and pin 14. Due to the combined resistance of the two termination resistors at approximately 120 Ohms each, the overall resistance should be read as 60 Ohms.

OBD-II may provide access to numerous data from one or more Electronic Control Units (ECU) within a vehicle and may offer a valuable source of information when logging behavior or troubleshooting problems inside a vehicle. The SAE J1979 standard defines a method for requesting various diagnostic data and a list of standard parameters that might be available from an ECU. The various parameters that are available are addressed by parameter identification numbers or PIDs which are defined in J1979.

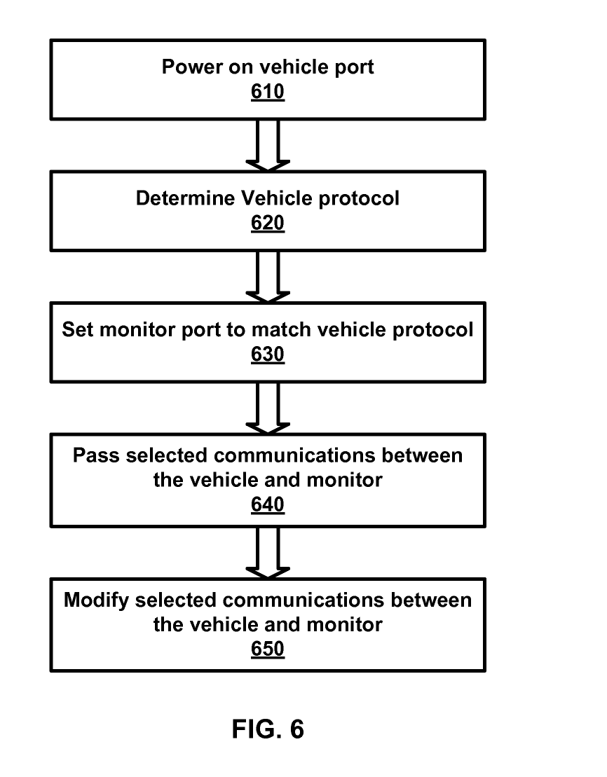

As illustrated in the example illustrated in FIG. 4, the data privacy device is an OBD data privacy device 410. A vehicle 445 may contain an on-board diagnostic system 440. The OBD 440 may communicate to a microcontroller 420 through a first CAN interface/driver 431. The microcontroller 420 may communicate to an OBD monitor through a second CAN interface/driver 432. CAN interface/driver(s) 431 and 432 may be configured to adapt to the processor. In some embodiments, the processor 420 may be configured to employ a CAN interface controller/driver circuit, an example of which is illustrated in FIG. 5. In some cases, the processor 420 may employ an internal CAN interface controller(s). In this type of embodiment, the processor maybe configured to employ CAN interface level driver(s) for CAN interface/driver circuits 431 and 432. In yet other embodiments, processor 420 may employ a processor that includes internal CAN interface driver(s) and internal CAN interface driver(s). In these types of embodiments, CAN interface/driver circuits 431 and 432 may not be required or may only provide minimal support circuitry. Additionally, a user interface 433 may be used to communicate with a user 460. The user interface may be configured to utilize any number of electrical and/or communications protocols that employ wireless and wired communications technologies.

FIG. 5 illustrates an embodiment of a conditioning circuit that may convert signals between a digital level to/from CAN level(s). The MCP2551 510 is a high-speed CAN transceiver manufactured by Microchip Technology Inc. of Chandler Ariz. The MCP2551 510 may serve as an interface between a CAN protocol controller and a physical communications bus. The MCP2551 510 may provide differential transmit and receive capability for the CAN protocol controller. MCP2551 510 may operate at speeds of up to 1 Mb/s. Typically, each node in a CAN system has a device to convert the digital signals generated by a CAN controller to signals suitable for transmission over the bus cabling (differential output). It also provides a buffer between the CAN controller and the high-voltage spikes that may be generated on the CAN bus by outside sources (EMI, ESD, electrical transients, etc.).

The CAN bus may have two states: Dominant and Recessive. A dominant state may occur when the differential voltage between CANH 507 and CANL 506 is greater than a defined voltage (e.g., 1.2V). A recessive state may occur when the differential voltage is less than a defined voltage (typically around 0V). The dominant and recessive states correspond to the low and high state of the TxD 501 pin, respectively. The CANL 506 output may drive the low side of the CAN differential bus. The CANH 507 output may drive the high-side of the CAN differential bus.

The RxD 504 pin may reflect the differential bus voltage between CANH 507 and CANL 506. RXD 504 may be connected to a receiver data pin on microcontroller 410. The low and high states of the RxD 504 output pin may correspond to the dominant and recessive states of the CAN bus, respectively. In other words, RxD 504 may be high when the CAN bus is recessive and low in the dominant state.

TxD 501 may be a TTL-compatible input pin. The data on this pin may be driven out on the CANH 507 and CANL 506 differential output pins. TxD 501 may be connected to a transmitter data output pin on microcontroller 410. When TxD 501 is low, CANH 507 and CANL 506 may be in the dominant state. When TxD 501 is high, CANH 507 and CANL 506 may be in the recessive state.

Although FIG. 5 illustrates an example CAN interface circuit using a Microchip MCP2551, one skilled in the art will recognize that other components may be employed to build such as circuit including: discrete components, a PCA82C251 manufactured by NXP Semiconductors N.V. of Eindhoven, The Netherlands; the SN65LBC031 manufactured by Texas Instruments of Dallas, Tex., and the LT1796 manufactured by Linear Technology of Milpitas, Calif.

The CAN bus may be used in vehicles. Currently, most new vehicles sold in the US implement the CAN bus, thus eliminating the ambiguity of the existing signaling protocols.

There are multiple protocols used with the OBD-II interface, and often it is possible to make an educated guess about the protocol in use based on which pins are present and/or have signals carried on them on the J1962 connector. The protocols include: SAE J1850 PWM, SAE J1850 VPW, ISO 9141-2, ISO 14230 KWP2000, and ISO 15765 CAN.

The SAE J1850 PWM specification communicates at 41.6 kbaud. Some of the configurations include pin 2: Bus− signal; pin 10: Bus+ signal; high voltage is +5V; and the message length is restricted to 12 bytes, including CRC. The specification may employ a multi-master arbitration scheme called Carrier Sense Multiple Access with Non-Destructive Arbitration (CSMA/NDA).

SAE J1850 VPW specification communicates at 10.4/41.6 kbaud and employs a Variable Pulse Width. Some of the configurations include: pin 2: Bus+; Bus idles low; High voltage is +7V; Decision point is approximately +3.5V; and the message length is restricted to 12 bytes, including CRC. The specification may employ CSMA/NDA.

The ISO 9141-2 specification employs a data rate of 10.4 kbaud, and is similar to RS-232. Some of the configurations include: pin 7: K-line; pin 15: L-line (optional); UART signaling (though not RS-232 voltage levels); K-line idles high; High voltage is Vbatt; and the message length is restricted to 12 bytes, including CRC.

ISO 14230 KWP2000 is a Keyword Protocol. Some of the configurations include: pin 7: K-line; pin 15: L-line (optional); Physical layer identical to ISO 9141-2; Data rate of 1.2 to 10.4 kbaud; and the message may contain up to 255 bytes in the data field.

Some of the ISO 15765 CAN protocol configurations include: 250 kbit/sec or 500 kbit/sec communications; pin 6: CAN High; pin 14: CAN Low;

Note that pins 4 (battery ground) and 16 (battery positive) are present in all configurations. Also, ISO 9141 and ISO 14230 may use the same pin out, thus it may be hard to distinguish between the two simply by examining the connector.

Processor 230 and/or 420 may be any number of computing machines including a microcontroller or a programmable logic device. Alternatively, the processor may include a computing machine such as laptop or customized processor. According to some embodiments the processor may need to have a communications capability configured to communicate with the OBD interface. On a fast processor, the communications may be achieved using software/firmware. Some processors have a serial communications capability.

According to some embodiments, the processor may communicate with a user through an additional serial port. The port may communicate by employing a communications circuit that is compatible with USB; RS232, Ethernet, Bluetooth or the like. The communications circuit may be external or internal to the processor.

The user may communicate to the processor using a suitably configured terminal program, a customized program, or the like. Configurations may include using a compatible data rate, number of data bits, parity bits, stop bits and line end mode. Example setting may include: 9600 baud or 38400 baud, 8 data bits, no parity bits, and 1 stop bit, terminate lines with a single carriage return character and/or optionally, a linefeed character.

Any suitable microcontroller may be used, although selection may be made based upon several criteria such as the amount of RAM, number of UARTS, number of CAN interfaces, power consumption, etc. For example, if the microcontroller is to communicate with two OBD devices and a user, a microcontroller with 3 or more UARTS may be employed. Examples of such microcontrollers may be selected from the following: PIC series microcontrollers manufactured by Microchip Technology Inc. of CHANDLER, ARIZONA, ATxmega series controllers manufactured by Atmel Corporation of San Jose, Calif.; STR series microcontrollers manufactured by STMicroelectronics of Geneva Switzerland; AX series microcontrollers manufactured by Asix Electronics Corporation of Hsinchu, Taiwan; PXA series or LH series microcontrollers manufactured by NXP of Eindhoven, The Netherlands; DS series microcontrollers manufactured by Maxim Integrated Products of Sunnyvale, Calif.; or MCF series microcontrollers manufactured by Freescale Semiconductor Inc. of Austin, Tex.

For example, the Microchip Technology Inc. PIC18CXXX microcontrollers for 8- and 16-bit applications may be used with the PIC18CX58 Controller Area Network (CAN) family. The 68-pin PIC18C658 and the 84-pin PIC18C858 offer 32 K bytes of OTP program memory and 1,536 bytes of user RAM and feature CAN 2.0B active peripheral interface and OTP memory options for design flexibility. Some of the PIC18CXXX cores combine a 10 MIPS CPU and 32 K bytes of program memory with an intelligent CAN interface, allowing control algorithms and network interfaces to be executed on the same microcontroller. The CAN interface contains a double-buffered receiver with two priority levels, six full acceptance filters, and two acceptance masks. Three transmit buffers are available for application-specified prioritization and abort filter. Other CAN interface features include programmable wake-up to manage power consumption, an integrated low-pass filter to minimize false starts from noise, a programmable loop-back mode to support self-test operation, a programmable baud rate clock source and a programmable link to timer module for time-stamping and network synchronization.

Talking to the Vehicles

Standards state that each OBD command or request that is sent to the vehicle adhere to a set format. The first byte sent (known as the ‘mode’) describes the type of data being requested, while the second byte (and possibly a third or more) specifies the actual information that is required. The bytes which follow after the mode byte are known as the ‘parameter identification’ or PID number bytes. The modes and PIDs are described in documents such as the SAE J1979 (ISO 15031-5) standard, and may also be extended or otherwise defined by the vehicle manufacturers.

The SAE J1979 standard currently defines possible diagnostic test modes, which include: 01—show current data; 02—show freeze frame data; 03—show diagnostic trouble codes; 04—clear trouble codes and stored values; 05—test results, oxygen sensors; 06—test results, non-continuously monitored; 07—show ‘pending’ trouble codes; 08—special control mode; 09—request vehicle information; and OA—request permanent trouble codes.

Some vehicles may not support all of the modes, and within modes, they may not support all possible PIDs (some of the first OBD II vehicles only supported a very small number of them). Within each mode, PID 00 may be reserved to show which PIDs are supported by that mode. Mode 01, PID 00 may be supported by all vehicles.

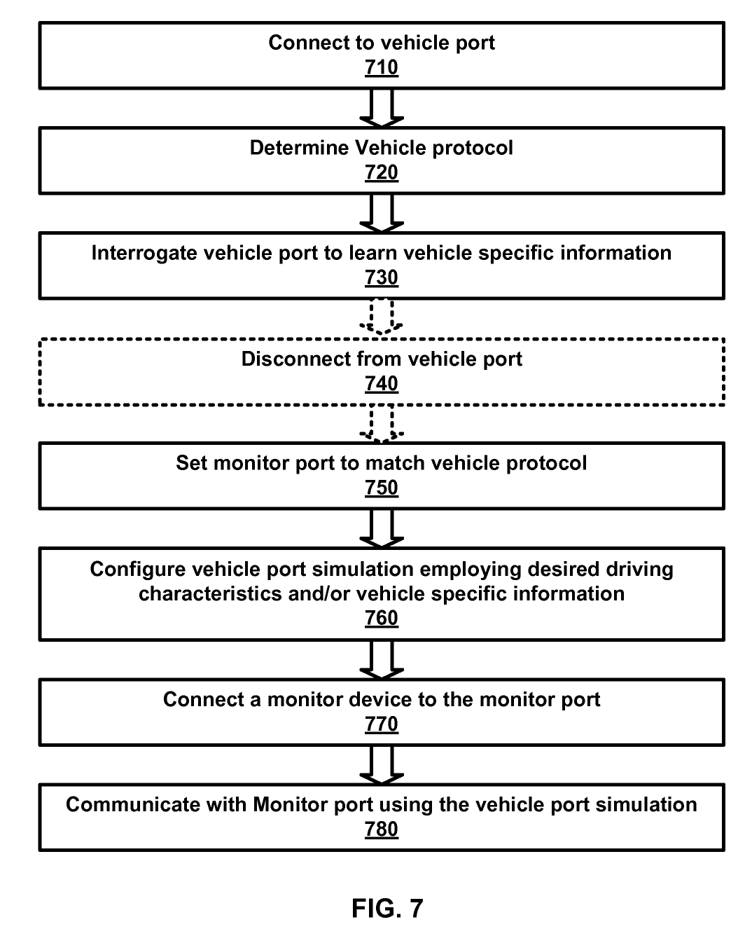

FIG. 6 is a flow diagram of an aspect of an embodiment of the present invention. Parts of the flow diagram may be implemented as a series of computer readable instructions on a non-transient computer readable media that when executed by one or more processors, causes the processors to perform a process.

According to some embodiments, detection of a connection to a host vehicle OBD port may occur at 610. This detection may occur when, for example, a vehicle is started. Some commercial vehicles may not respond without the ignition key in the ON position. In other embodiments, detection of a connection may be determined through vehicle supplied voltages at some connector pins. In some embodiments, other measurements may be used such as impedances at some of the connector pins.

According to some embodiments, a protocol determination step may be made at 620. One method to determine the protocol at a vehicle port is to, for example, interrogate a vehicle OBD II port sequentially using a multitude of protocols and look for a valid response. One skilled in the art will recognize that other protocol determination processes may be used. For example, in an alternative embodiment, the device may be configured for a specific protocol during a setup process. In yet another embodiment, the device may be told what kind of vehicle it is connecting with and determine the protocol through a lookup table.

Protocols may include, but are not limited to: GM [VPW], Ford [PWM], ISO, and Advanced ISO [KWP]. When the language of the vehicle is identified, the vehicle port protocol and any associated hardware options may be configured. For example, particular pin array functionality and parameters necessary for reading data passing through the pin array may be selected. At this point, embodiments should be able to communicate with the vehicle OBD port. At 630, the monitor port may be configured to match the configuration of the vehicle OBD II port.

Once configured, the vehicle data privacy device may start normal operations by passing selected communications between the vehicle and monitor device at 640. Many communications, especially unknown communications may be passed back and forth unaltered. Because many codes may be unknown, it may be important to let OBD data pass between the vehicle connector and the monitor connector. Some communications may be selectively deleted from the communications. For example, one may desire to hide the existence of a particular subsystem in a vehicle, such as a GPS unit or a built in phone system. In these cases, communication responses from such subsystem(s) could be selectively ignored. In other words, the data privacy device may decide to selectively not pass these communications to the monitor device. From the monitor's perspective, it may appear that the subsystem is either not there or turned off. The data privacy device may be configured to store and track these unknown codes for later review and analysis.

Similarly, some embodiments may modify selected communications between the vehicle and monitor at 650. In these cases, instead of not forwarding communications between a subsystem or sensor and a monitor, the communications could instead be modified. For example, speed or RPM data could be modified to show different behavior than is actually occurring on the vehicle. In the case of a built in GPS, the data could be modified to report different GPS data than the GPS is actually measuring.

Selected communications for modification may include all or part of communications related to one or more subsystem(s), or may be for only a subset of the communications associated with one or more subsystem(s). These communications may be based on the type of communication (e.g. specific message type), and/or temporal related communications, for example damping acceleration or deceleration rate data during periods where the actual vehicle acceleration/deceleration is outside of some configured boundary.

To protect privacy, some users may disconnect a monitor during a trip. However, some monitors may include tamper detection processes. One method some monitors may use to detect when a unit is disconnected may include measuring time when there is a drop in voltage caused by the disconnection. Some embodiments of the present invention may counter this tamper detection technique by proving a normal operating voltage connection at the monitor OBD port.

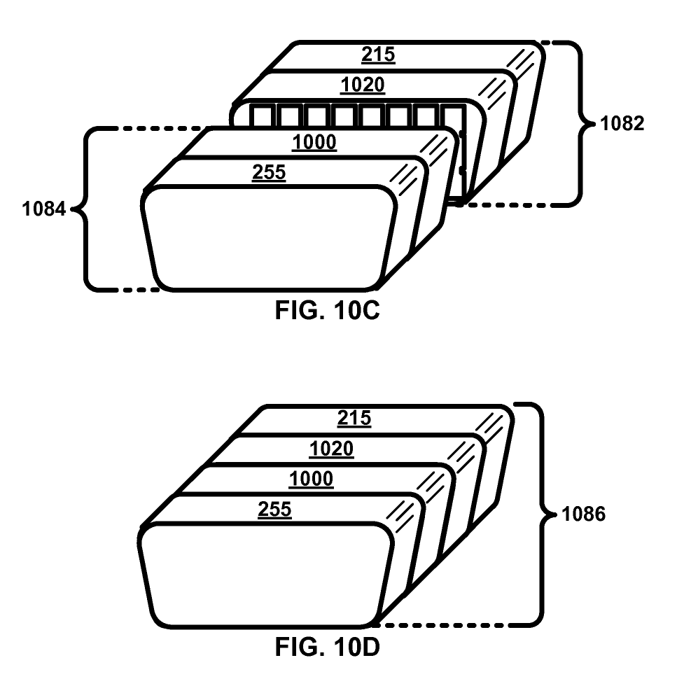

According to some of the various embodiments, trip times, routes, destinations and/or the like may be obfuscated to enhance privacy by creating a hidden or virtual trip. FIGS. 10A, 10B, 10C and 10D show an example illustration of addition embodiments that may include the addition of a second data privacy device 1000 that may be employed to create virtual trips. As shown in an illustrative embodiment in FIG. 10B, a privacy device combination 1081 may be configured using 2 parts: first data privacy device 1020 and second data privacy device 1000. These two parts may be separated as illustrated in FIG. 10C at connectors 4 and 1012 such that the monitor 255 is connected to second data privacy device 1000 as combination 1084. In this example, combination 1082 may be fashioned by connecting first data privacy device 1020 with on-board diagnostic system 215 via connectors 1022 and 315 while a second combination 1084 may be fashioned by connecting data privacy device 1000 with monitor 255 via connectors 1014 and 355. The combination 1082 may be configured to monitor a real trip while combination 1084 may keep monitor 255 alive when separated from combination 1082.

As such, this configuration enables the monitor 255 to be detached from the OBD port while combination 1082 remains connected within the vehicle and continues to collect information from the vehicle during operation. Combination 1084 may allow second data privacy device 1000 to provide power and other keep-alive signals to monitor 255 so that the monitor 255 may believe it is still attached to a vehicle. For example, combination 1084 may be configured to make the vehicle look like it is in a stationary and/or “off” state.

First data privacy device 1020 and second data privacy device 1000 may include hardware similar to data privacy device 200 described herein. (e.g. interface(s), processor(s), memory). Additionally, second data privacy device 1000 may have en external power input to operate itself as well as monitor 255 when not connected to first data privacy device 1020. Circuitry to switch between power sources may be used to prevent the external power source from shorting with power pins at the interface(s).

Combination 1082 may be configured to remain with the vehicle and collect actual characteristics from the vehicle. This data may be employed to create a virtual, or enhanced, future trip. For example distance traveled, fuel level status, miles till next service level, etc. Thus, combination 1082 may also need interface(s), processor(s), memory, an external power input, and/or the like.

In this example, a “virtual” trip may be provided to monitor 255 at another time (e.g. after the original trip) that matches at least some of the characteristics of the hidden trip recorded by first data privacy device 1020. For example, the virtual trip may have the same total distance traveled, but take place from 8:00 AM to 8:15 AM rather than 1:05 AM to 1:20 AM and/or also have a more moderated acceleration and deceleration characteristics. Virtual trip(s) may also be integrated into one or more follow-up real trips once the combination 1084 is reattached within the vehicle to combination 1082 via connectors 1024 and 1012 forming combination 1086. To integrate a virtual trip, the real trip may for example be at a higher rate of average speed (to catch up on total mileage).

In some operations, combination 1086 may be fashioned by connecting combination 1082 and 1086 via connectors 1024 and 1012. Combination 1086 may be employed to perform privacy functions already discussed, by, for example, configuring second data privacy device 1000 to act a pass through device between monitor 255 and first data privacy device 1020. Connectors 1012 and 1024 may be different from the other connectors. For example, these connectors may have different protocols or electrical connections.

Some monitor devices may desire to measure acceleration and deceleration data. They may accomplish this by monitoring vehicle speed on a periodic basis, such as once every second or so. Thereafter, the monitor device may use recorded speeds to calculate acceleration and deceleration values. To overcome these measurements, embodiments of the present invention may modify reported speeds so that calculated accelerations and decelerations will be within a predetermined range. According to some embodiments, these reported values may vary as to not consistently report similar accelerations and decelerations.

Some monitor devices may desire to detect and record and/or report unusual events. Unusual events may include probable accidents, probable near accidents, prolonged idling, or the like. An example of an unusual event may include where deceleration has a threshold greater than certain preset limits, and the vehicle speed goes to zero. To overcome these unusual event detections, embodiments of the present invention may modify reported speeds so as to indicate normal behavior during an unusual event. For example, where a vehicle may have decelerated quickly and then stopped, the data may be modified to indicate a slow deceleration and then some normal driving activity before reporting a stop.

Some monitor devices may desire to detect and record and/or report the length of a trip. To accomplish this, some monitors may employ information about when a vehicle starts a trip and when a vehicle ends a trip. To modify this reporting, some embodiments of the present invention may modify data that may be used to detect when a vehicle starts and stops such as rpm, data speed data, voltage data, on/off signaling data or the like.

There are many ways to detect the start of a vehicle. For example, when the OBD reports an engine RPM above some threshold, such as 350 rpm, it may be possible to deduce that the vehicle is operating. Another method may include monitoring vehicle voltage in combination with measuring RPM. For example, vehicle voltage is monitored to determine if its voltage has changed in character with the use of a starter motor and then interrogate the vehicle RPM's. The RPMs may be selected to be greater than the starting motor induced rpm to insure that the engine is idling. It is envisioned that other methods may be used to determine whether the vehicle is started. It may be possible to merely interrogate some vehicles to determine their “on” status. For example, with some electric or hybrid cars, measuring an idle rpm may be less effective. Also, the vehicles reported rate of travel (speed) may also be employed.

There may be several ways to determine when a vehicle has stopped, in addition to speed parameter(s). For example, one method a monitor may use to determine when a vehicle has stopped may include periodically monitoring engine speed to determine whether RPMs are below a certain preset limit, such as 350 or 400 RPMs. If engine speed is detected to have fallen below the preset amount, it may presume that the trip is ended.

Using a timer, the monitor may determine the time of a trip between a detected vehicle start and a detected vehicle stop. Additionally, the monitor may determine the length of a trip using time data and speed data. To overcome a monitor detecting a trip that is to long or short, temporally or spatially, some embodiments of the present invention may modify data that may be used to detect when a vehicle starts and stops such as rpm, data speed data, voltage data, on/off signaling data or the like. Embodiments of the present invention may modify reported speeds to conform to a desired trip length. Note that this may require ongoing modifications to the odometer readings available through the OBD as well to conform to the modified trip durations.

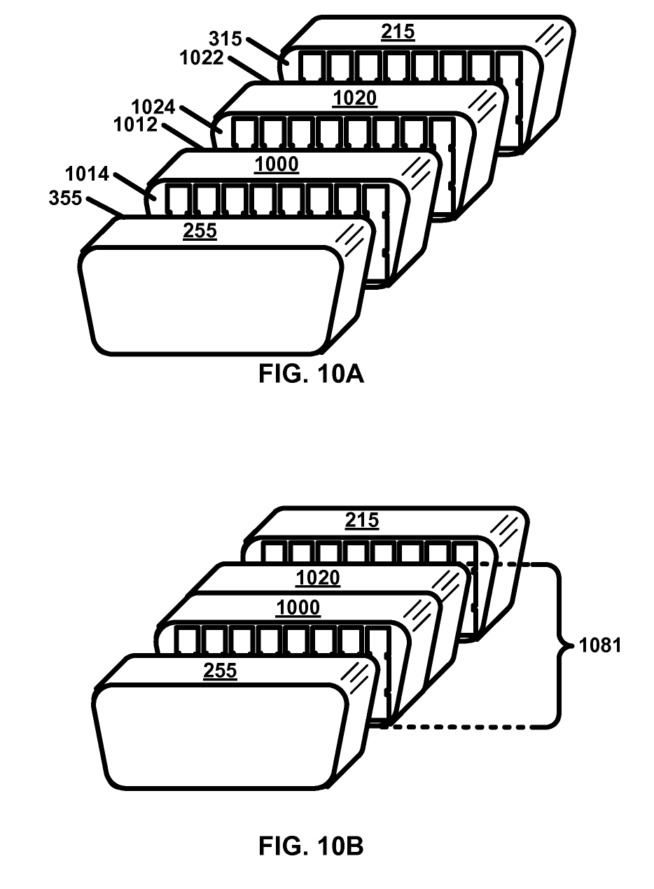

Some monitor devices may analyze data over an elapsed time period to learn about the driving habits associated with a monitored vehicle. For example, elapsed time relative to speed, engine speed, cooling temperature, engine load, battery voltage, steering information, lane positioning information, loss of traction information, or the like may be recorded. Using this type of data collected over an elapsed time period, acceleration and deceleration as well as distance traveled may be determined, the former by differentiation and the latter by integration. For example, some monitor devices may employ this kind of data to deduce whether a vehicle is associated with particular driving habit such as “following too close” by analyzing the data to look for numerous hard and extreme braking incidents. This kind of detected behavior may also indicate abuse of the vehicle with rapid accelerations. To overcome a monitor detecting these types and other driving habits, some embodiments of the present invention may modify data that may be used to deduce various driving habits. For example, as shown in FIG. 9, speed data 910 may be soothed to keep rapid accelerations 930 and decelerations 940 below some defined rate of change (e.g. 7 mph/sec.). However, the modified data 920 in this example may need to ensure that the speed data corresponds to distance traveled data (e.g. from a GPS) over measured travel time. To accomplish this, the area under raw data curve 920 may be managed to approximate the area under modified data curve 910. To further assist in smoothing data, it may be helpful to delay all the data reported to the monitor by some period of time. This delay may allow the smoothing to take advantage of knowing data before and after the current data is collected. The delay period may be selected to correspond with normal error/collection limits of external data that may be available to the monitor, such as the real time of day, the real location, or the like.

Some monitors may trigger an “accident log” recording data around some data indicative of a possible accident such as a rapid deceleration. Because such a monitor may attempt to preserve this type of data, embodiments of the present invention may modify or stop passing this data to the monitor.

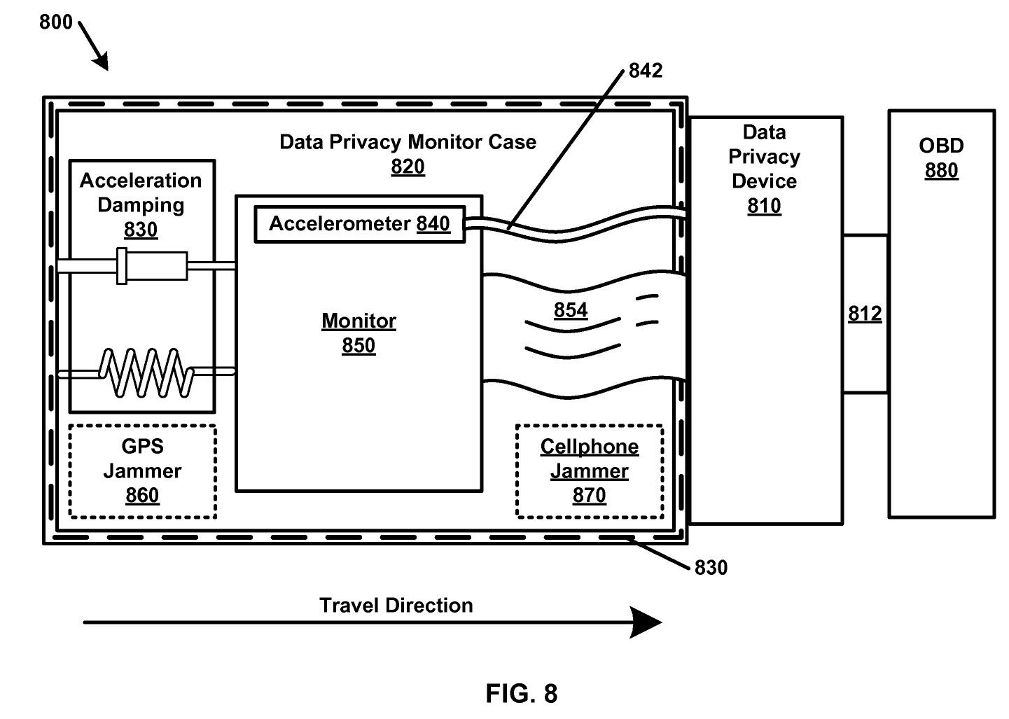

FIG. 7 is a flow diagram illustrating different aspects of embodiments that may be used to simulate vehicle data to a monitor without being connected to a vehicle. Some embodiments may have a learning type mode to collect vehicle specific information from a vehicle that may be used to increase the accuracy of a simulation. For example, at 710 some embodiments may be connected to a vehicle port, determine the vehicles protocol at 720 and then interrogate the vehicle port at 730 to learn vehicle specific information from the vehicle. Vehicle specific information may include vehicle identifying data, characteristic behavior of a vehicle or the like. In some cases, this learning mode may be improved by driving the vehicle while collecting vehicle specific information. At 740, embodiments may be disconnected from the vehicle port after collecting vehicle specific information.

According to some embodiments, the monitor port may be set to match the vehicle protocol at 750. The vehicle protocol may have been learned any number of ways including through a previous determination by the embodiment when connected to a specific vehicle or by being configured to use a specific protocol. At 760, a vehicle port simulation may be configured employing desired driving characteristics and/or vehicle specific information. The vehicle specific information may have been learned any number of ways including through a previous determination by the embodiment when connected to a specific vehicle or by being configured to employ specific vehicle information. Similarly, desired driving characteristics may have been learned, created, selected or the like. Examples of desired driving characteristics may include, but are not limited to: time of day to drive, braking and acceleration habits, temporal and spatial trip lengths, or the like. These characteristics may cross multiple days of driving. At 770, an embodiment may be connected to a monitor OBD port without the vehicle port being connected to a vehicle. At 780, the example embodiment may interact with the monitor using a simulation mode to report data associated with a simulated trip to make it appear that the vehicle has been used in a particular manner.

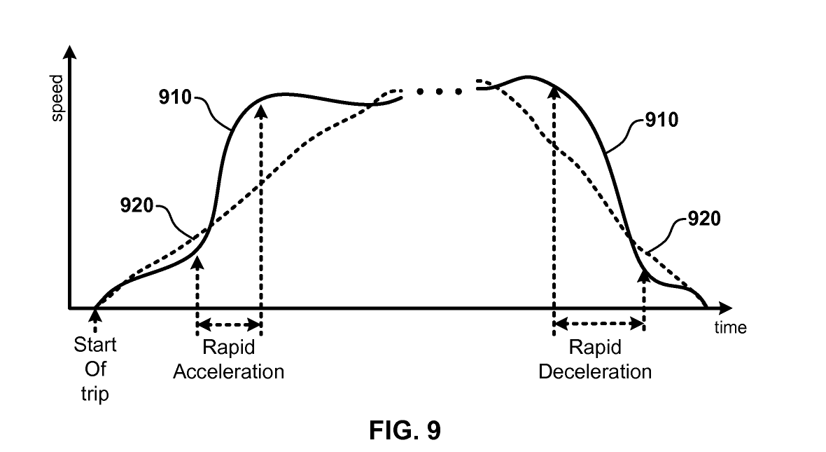

FIG. 8 is an example diagram of a system 800 using a data privacy monitor case 820 configured to operate in conjunction with a data privacy device 810 as per an aspect of an embodiment of the present invention. Some monitors 850 may collect external data not derived from an OBD system 880. For example, some monitors 850 may collect data from an external accelerometer, a GPS unit, and inertial navigation unit, or the like. This data may be used to learn about operational characteristics of a vehicle, absent OBD 880 generated data. Additionally, externally derived data may be used to verify the accuracy of OBD 880 generated data.

As illustrated, in this example embodiment, monitor 850 may be mounted in a data privacy monitor case 820. Monitor 850 may be connected to data privacy device over a first interface 854 to data privacy device 810. Interface 854 may include a cable(s), connectors(s), or the like. Data privacy device 810 may be connected to OBD 880 by an interface 812. Interface 812 may include a cable(s), connectors(s), or the like.

Data privacy monitor case 820 may be configured to employ one or more mechanisms to protect privacy including, but not limited to: an acceleration damping mechanism 830, a GPS jamming device 860, a cellphone jamming device 870, a faraday shield 830, an accelerometer 840, or the like.

The acceleration damping device 830 may be employed to minimize G-forces that a monitor 850 experiences. The acceleration damping device 830 may be mounted in the data privacy monitor case 820 to dampen G-forces along at least the direction of vehicle travel. To accomplish this, the acceleration damping device 830 along with the data privacy monitor case 820 and monitor 850 may be disposed inside the vehicle along the axis defined by the front and rear of the vehicle. In some embodiments, the acceleration damping device 830 may include a mass-spring-damper system with spring and a damper. The system may be configured to dampen forces that would lead to an acceleration of the monitor by some predetermined amount (e.g. 7 mph/sec). Alternative embodiments may employ an active dampening system where the monitor 850 may be moved in response to a measured acceleration value to keep the monitor 850 movements within a predetermined range.

According to some embodiments, GPS jammer/blocker device 860 may be employed to selectively prevent the monitor from acquiring GPS data. This may useful when a person wished to protect privacy regarding their travel. A GPS jammer 860 may interfere with GPS satellite signals. In some cases, the GPS jammer/blocker device 860 may prevent a useful signal from reaching a monitor 850 GPS device. In some cases, the GPS jammer/blocker device 860 may provide a substitute signal for the monitor 850 GPS device to receive. Such a substitute signal may provide data that shows that the vehicle traveled to a different location or by a different route than it actually traveled.

According to some embodiments, cellphone jammer device 870 may be employed to selectively prevent the monitor from acquiring cellphone service. This may useful when a person wished to protect privacy regarding their travel past cell towers which may indicate their location or to prevent the upload of monitored data. A cellphone jammer device 870 may interfere with cellular signals. In some cases, the cellphone jammer device 870 may prevent a useful signal from reaching a monitor 850 cellular communications device. In some cases, the cellphone jammer device 870 may provide a substitute signal for the monitor 850 cellular device to communicate. Such a substitute signal may provide data that shows that the vehicle traveled to a different location or by a different route than it actually traveled.

According to some embodiments, a faraday shield 830 may be employed to prevent electromagnetic signals from passing through the walls of the data privacy monitor case 820. Faraday shield 830 may be implemented by encapsulating monitor 850 inside a conductive shield such as, but not limited to: metal foil, metal ribbon, cast metal, or the like. This may useful when a person wished to protect privacy by preventing aspects of the monitor 850 from communicating with the cellular networks, acquiring GPS satellite data or the like. In some embodiments, the shield may be retractable to allow selective communications to occur. For example, the shield could include metal plate that may be repositioned. Alternatively, the faraday shield may be implemented as a conductive bag or outer case that may be selectively removed.

According to some embodiments, an accelerometer 840 may be employed to measure the actual acceleration that monitor 850 is subject to inside data privacy monitor case 820. The acceleration data from accelerometer 840 may be communicated to data privacy device 810 via interface 842. Interface 842 may include a cable(s), connectors(s), or the like. Interface 842 may be integrated or part of interface 854. Data privacy device 810 may use this acceleration data when modifying OBD data to correspond to acceleration data independently generated by monitor 850.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e hardware with a biological element) or a combination thereof, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above-mentioned technologies may be used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) protecting privacy by adjusting or simulating vehicle data responses intended for a logging device. However, one skilled in the art will recognize that embodiments of the invention could be used protect privacy from other types of data loggers such as sensor loggers, computer use data recorders, event data recorders, voyage data recorders, or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. An apparatus comprising:
a. a first port configured to communicatively connect to an on-board diagnostic system;
b. a second port configured to communicatively connect to a monitor, the monitor configured to communicatively connect to the on-board diagnostic system; and
c. a processor configured to send managed data to the second port, the managed data configured to appear as if it originates from the on-board diagnostic system.

2. The apparatus according to claim 1, wherein:
a. the on-board diagnostic system is a vehicle on-board diagnostic system;
b. the monitor is vehicle monitor; and
c. the managed data is managed vehicle data.

3. The apparatus according to claim 1, wherein the first port is further configured to receive OBD data.

4. The apparatus according to claim 1, wherein the processor is further configured to generate at least some of the managed data by modifying selected data received at the first port.

5. The apparatus according to claim 1, wherein at least some of the managed data was received at the first port.

6. The apparatus according to claim 1, wherein at least some of the managed data was historical data received at the first port.

7. The apparatus according to claim 1, wherein at least some of the managed data is simulated data.

8. The apparatus according to claim 7, wherein at least some of the simulated data employs information determined through communications with the first port at a previous time.

9. The apparatus according to claim 7, wherein at least some of the simulated data employs driving characteristic data.

10. The apparatus according to claim 1, wherein the on-board diagnostic system employs at least one of the following to communicate:
a. an OBD port;
b. an OBD II port;
c. an RS-232 port;
d. a USB port;
e. an RS-422 port;
f. a LIN-Bus port;
g. a digital port; or
h. a combination of the above.

11. The apparatus according to claim 1, wherein the monitor employs at least one of the following to communicate:
a. an OBD port;
b. an OBD II port;
c. an RS-232 port;
d. a USB port;
e. an RS-422 port;
f. a LIN-Bus port;
g. a digital port; or
h. a combination of the above.

12. The apparatus according to claim 1, wherein the first port is one of the following:
a. an OBD port;
b. an OBD II port;
c. an RS-232 port;
d. a USB port;
e. an RS-422 port;
f. a LIN-Bus port;
g. a digital port; or
h. a combination of the above.

13. The apparatus according to claim 1, wherein the second port is one of the following:
a. an OBD port;
b. an OBD II port;
c. an RS-232 port;
d. a USB port;
e. an RS-422 port;
f. a LIN-Bus port;
g. a digital port; or
h. a combination of the above.

14. The apparatus according to claim 1, further including a signal conditioning circuit between the first port and the processor.

15. The apparatus according to claim 1, further including a signal conditioning circuit between the second port and the processor.

16. The apparatus according to claim 1, wherein at least some of the managed data includes:
a. modified speed data;
b. modified rpm data;
c. modified braking data;
d. modified force data;
e. modified voltage data;
f. modified time data;
g. modified date data; or
h. a combination of the above.

17. The apparatus according to claim 1, wherein at least a portion of the managed data is modified to make a vehicle employing the on-board diagnostic system appear to be at least one of the following:
a. turned off;
b. driving slowly;
c. accelerating slowly;
d. decelerating slowly; or
e. a combination of the above.

18. The apparatus according to claim 1, further including a signal conditioning circuit between the second port and the processor, the conditioning circuit configured to selectively emulate a vehicle in an off state.

19. The apparatus according to claim 1, further including a signal conditioning circuit between the first port and the processor, the conditioning circuit configured to selectively emulate a vehicle in an off state.

20. The apparatus according to claim 1, further including a third port configured to communicate with the processor.

21. The apparatus according to claim 1, further including an input/output interface configured to switch the apparatus between at least two modes, at least one of the at least two modes including:
a. an off mode;
b. a good driver mode;
c. a normal mode;
d. a pass through mode;
e. a simulation mode;
f. a driver training mode; or
g. a combination of the above.

22. The apparatus according to claim 1, further including a case to hold the monitor, the case including at least one of the following:
a. an acceleration dampening device;
b. a GPS jammer;
c. a GPS blocker;
d. a cellphone jammer;
e. a cellphone blocker;
f. a Faraday shield;
g. an accelerometer; or
h. a combination of the above.

23. A method comprising:
a. receiving vehicle data from an on-board diagnostic system;
b. employing at least one processor to generate managed data configured to appear as if it originates from the on-board diagnostic system; and
c. sending the managed vehicle data to a monitor, the monitor configured to connect to the on-board diagnostic system.

24. A non-transient computer readable media containing instructions that when executed by one or more processors, causes the one or more processors to perform a method comprising:
a. receiving vehicle data from an on-board diagnostic system;
b. generating managed data configured to appear as if it originates from the on-board diagnostic system; and
c. sending the managed data to a monitor, the monitor configured to connect to the on-board diagnostic system.
